(19) United States
(12) Patent Application Publication
(10) Pub. No.: US 2008/0159637 A1
(43) Pub. Date: Jul. 3, 2008

(54) Deblocking filter hardware accelerator with interlace frame support

(76) Inventor: Ricardo Citro, Scottsdale, AZ (US)

Correspondence Address: BUCKLEY, MASCHOFF & TALWALKAR LLC, 50 LOCUST AVENUE, NEW CANAAN, CT, 06840, US

(21) Appl. No.: 11/646,219

(22) Filed: Dec. 27, 2006

(51) Int. Cl. G06K 9/36; G06T 5/00; G06K 9/40

(52) U.S. Cl. 382/233; 382/232; 382/268; 382/248

(57) ABSTRACT

According to some embodiments, systems, methods, and apparatus are provided to load video data into a hardware accelerator that is not adapted to receive interlace frames, wherein the video data comprises interlace frames, configure the hardware accelerator to receive interlace frames, and de-block the video data via the hardware accelerator.

### BACKGROUND

In the world of digital video there are numerous coding standards including H.261, H.263, H.264, VC1, and WMV9. The basic processing unit of these standards may be a macroblock which may comprise a plurality of pixels. Each pixel may have a LUMA component and a croma component where the LUMA samples represent the brightness of a video image and the CHROMA samples represent the color information. Accordingly, each macroblock may comprise one or more arrays of LUMA samples and one or more arrays of CHROMA samples.

While an encoded video image is being decoded, deblocking filtering, sometimes referred to as block edge filtering, may be performed on the decoded video image prior to the video image being displayed. De-blocking filtering may reduce the appearance of block-shaped artifacts caused by block-based motion compensation and spatial transform of the coding standard.

### BRIEF DESCRIPTION OF THE DRAWINGS

FIG. 1 illustrates an apparatus according to some embodiments.

FIG. 2 is a block diagram of a method according to some embodiments.

FIG. 3 illustrates a microinstruction according to some embodiments.

FIG. 4 illustrates a microinstruction according to some embodiments.

FIG. 5 illustrates a microinstruction according to some embodiments.

FIG. 6 illustrates a plurality of tables according to some embodiments

FIG. 7 is a block diagram of a method according to some embodiments.

FIG. 8 illustrates a microinstruction according to some embodiments.

FIG. 9 illustrates blocks and edges according to some embodiments.

FIG. 10 illustrates blocks and edges according to some embodiments.

FIG. 11 illustrates a microinstruction according to some embodiments.

FIG. 12 illustrates a microinstruction according to some embodiments.

FIG. 13 illustrates a plurality of tables according to some embodiments.

FIG. 14 illustrates a microinstruction according to some embodiments.

FIG. 15 illustrates blocks and edges according to some embodiments.

FIG. 16 illustrates blocks and edges according to some embodiments.

FIG. 17 illustrates blocks and edges according to some embodiments.

FIG. 18 illustrates a microinstruction according to some embodiments.

FIG. 19 illustrates a plurality of tables according to some embodiments.

FIG. 20 is a block diagram of a system according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

### Hardware Accelerator Apparatus

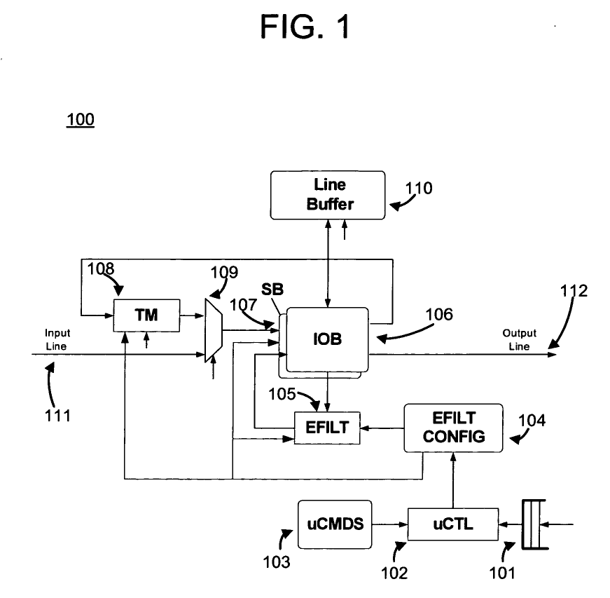

Now referring to FIG. 1, an embodiment of a hardware accelerator 100 is shown. In some embodiments, the hardware accelerator 100 may be a de-blocking filter hardware accelerator that may perform overlapping transforms, de-blocking filtering operations, and in-loop transforms. In some embodiments, the hardware accelerator 100 may be provided a set of commands and memory resources to allow implementation of standard de-blocking filtering by decomposing the de-blocking filtering process into a sequence of operations that may utilize small sub-sets of a video frame at a given point in time. In some embodiments, the size of a sub-set may be one macro-block (“MB”) plus surrounding adjacent pixels because the filtering of a new MB may require pixels of adjacent MB's, and may include pixels of a MB that may not be present in memory.

While some video encoding standards may specify de-blocking filtering operation at a frame level (e.g. WMV9, VC1, H.263), other standards may allow de-blocking filtering on a MB by MB basis (e.g. H.264). In some embodiments, a filtering operation may be triggered by a presence of a new MB generated from a decoding process. In some embodiments, the filtering of a MB may be performed partially and may be completed when the data of the adjacent MB is fully available.

The hardware accelerator 100 may support video compression/decompression algorithms (“codec”) such as, but not limited to, VC1 Main Profile, Advanced Profile Progressive and Interlace Field. However, in some embodiments the hardware accelerator 100 may not be able to support interlace frames without changes being made to the hardware accelerator to support interlace frames. For example, changes may include more resources such as, but not limited to, new tables to support internal buffer management, changes in microcode commands, and a larger line buffer 110 which may provide more storage than conventional embodiments.

The hardware accelerator 100 may comprise a command queue 101, a micro controller 102, a micro command cache 103, an edge filter configuration unit 104, an edge filter unit 105, one or more input/output buffers 106, a shadow buffer 107, a transpose control logic unit 108, a multiplexer 109, and one or more line buffers 110.

The command queue 101 may queue commands to be executed by the hardware accelerator 100. In some embodiments, two commands may be loaded into the command queue at a same time. A first of the two commands may be executed while a second of the two commands may wait to be executed.

The micro command cache 103 may comprise memory to store commands or instructions that may be used more frequently than other commands or instructions. The micro controller 102 may pull commands from either the command queue 101 or the micro command queue 103 and may allow parallelization of events, such as, but not limited to loading a second MB into the input/output buffers 106 while a first MB is being filtered In some embodiments, the micro controller may transmit a command or instruction to the edge filter configuration unit 104.

When the edge filter configuration unit 104 receives a command from the micro controller 102, it may configure the edge filter unit 105 based on a standard (e.g. VC1, H.264) indicated in the command or instruction. For example, the command may indicate to the edge filter unit 105 that a coding standard of VC1 will be used. Using this information, the edge filter configuration unit 104 may adjust the edge filter unit 105 to receive video data coded based on a VC1 standard. In some embodiments, the edge filter configuration unit 104 may configure the transpose control logic unit 108, the input/output buffer 106 and the shadow buffer 107 based on an indicated coding standard.

An input line 111 may input a macro-block or video data into the hardware accelerator 100 and a de-blocked macro-block or video data may be output from the hardware accelerator 100 via an output line 112.

The input/output buffer 106 and the shadow buffer 107 may store a macro-block or portions of a macro-block or video data during filtering of the video pixels or data. In some embodiments, the input/output buffer 106 may comprise two input/output buffers, one to store CHROMA information and one to store LUMA information. The transpose control logic unit (“TM”) 108 may transpose pixels of a MB or video data. In some embodiments, the TM 108 may transpose a plurality of pixels and load the transposed plurality of pixels into the shadow buffer 107 via the multiplexer 109. In some embodiments, the TM 108 may load the transposed pixels into the shadow buffer 107 in two sets of 16×8 pixels instead of one set of 16×16 pixels as used in conventional embodiments. In some embodiments, the TM 108 may transpose pixels from the shadow buffer 107 to one or more input/output buffers 106.

### Method

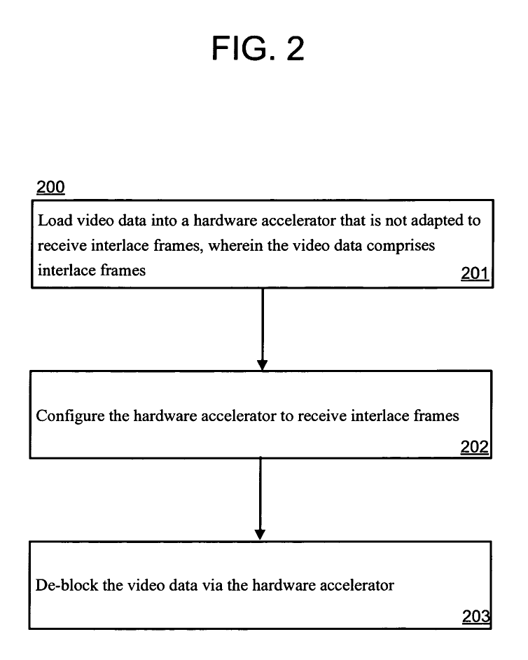

Now referring to FIG. 2, an embodiment of a method 200 is shown. The method 200 may be executed by any combination of hardware, software, and firmware, including but not limited to, the hardware accelerator 100 of FIG. 1. Some embodiments of the method 200 may allow a hardware accelerator that is not adapted to filter interlace frames to filter video data comprising interlace frames. At 201, video data is loaded into a hardware accelerator that may not be adapted to receive interlace frames where the video data comprises interlace frames. At 202, the hardware accelerator is configured to receive interlace frames. In some embodiments, the hardware accelerator may be configured to receive interlace frames by a microcode command.

### Microcode Command

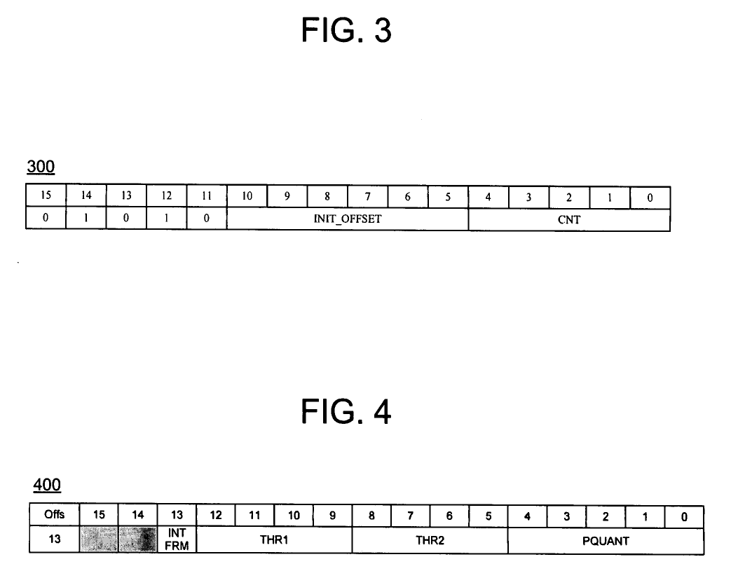

FIG. 3 and FIG. 4 illustrate an embodiment of a first word 300 of a microcode command and a second word 400 of the microcode command. The first word 300 may comprise 16 bits and may define a command to execute in bits 11 through 15. Bits 5 through 10 of the first word 300 may comprise an INIT_OFFSET field that may indicate an offset to the first configuration word being loaded within an edge filter configuration unit register or memory. The second word 400 may comprise an interlace frame “INT FRM” identification field and in some embodiments, bit 13 of the second word may define the INT FRM field.

In order to support interlace frames, a hardware accelerator may need to use a different computation process than conventional Moving Picture Experts Group (“MPEG”) frames (e.g. I-frames, P-frames, and B-frames). For example, interlace frame information may need to propagate to one or more units of the hardware accelerator to allow processing of interlace frames. In one embodiment, a predetermined value, such as, but not limited to 13, in the INIT_OFFSET field may indicate that the second word 400 will be read. If the INT FRM field is set when the second word 400 is read, then a indication or signal that interlace frames may be processed may be transmitted to one or more elements of the hardware accelerator 100. In some embodiments, the indication that interlace frames may be processed may comprise one or more microcode commands, such as, but not limited to, commands to load tables, clamp, mask, unload pixels, and/or transpose.

For example, if a microcode command comprising first word 300 and second word 400 arrives into an edge filter configuration unit with an INIT_OFFSET field set to 13 and the INT FRM field of second word 400 is set (e.g. set to a 1) then the hardware accelerator may be configured to process interlace frames. If the INT FRM field is not set, then the hardware accelerator 100 may not be configured for interlace frame. In response to the INT FRM field being set, the edge filter configuration unit may configure the hardware accelerator to process interlace frames by reconfiguring the transpose control logic unit, the edge filter unit, and the shadow buffer to process interlace frames. In some embodiments, one or more microcode commands may reconfigure the transpose control logic unit, the edge filter unit, and the shadow buffer to process interlace frames.

At 203, the video data is de-blocked via the hardware accelerator.

### Load Tables into the Hardware Accelerator

In some embodiments, when a hardware accelerator, such as the hardware accelerator 100 of FIG. 1, receives an instruction to support interlace frames, the video image may be loaded according to one or more tables. In some embodiments, the tables may be hardwired tables that manage a location to load video information into internal buffers.

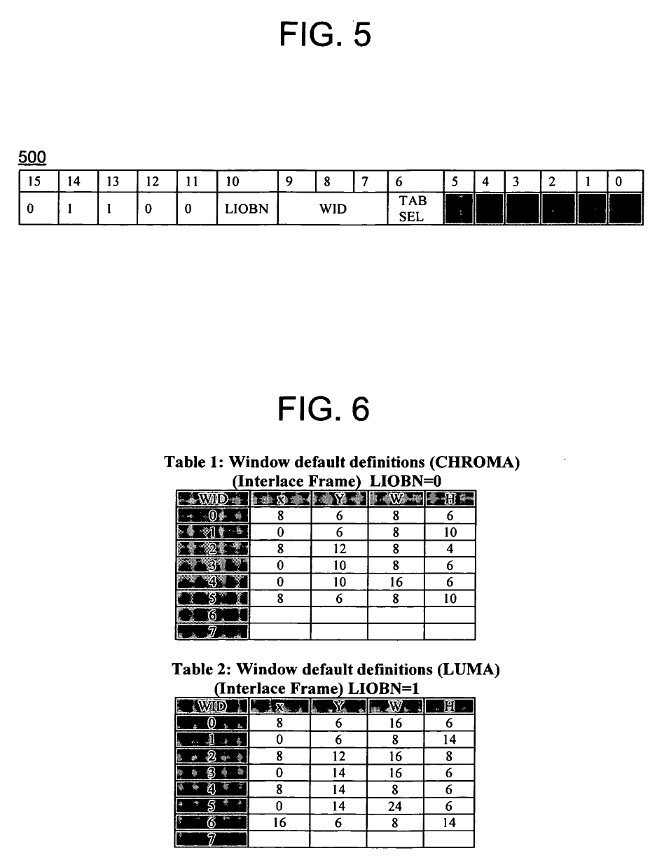

Since an interlace frame type or video data may require filtering one MB at a time, a load window command may be used to load the input data into the hardware accelerator 100. The load window command may load a MB or video data either row wise or column wise. In some embodiments, in order for the hardware accelerator 100 to process interlace frames, two tables indexed by a window identification (“WID”) field may be added to the hardware accelerator 100. The two tables may be selected based on a bit in a load window microcode command 500. An embodiment of the load window microcode command 500 is shown in FIG. 5.

In some embodiments, and as illustrated in FIG. 5, bit six, the table select (“TAB SEL” field may identify a default table indexed by a processing window identification (“PWID”) field that may load an interlace frame type or video data into an input/output buffer, such as input/output buffer 106 of FIG. 1. In some embodiments, if the TAB SEL field is set to 0 then the PWID field may index a LUMA/CHROMA table for Main Profile, Advanced Profile Progressive and Interlace Field as used in conventional embodiments. However, if the TAB SEL field is set to 1, then the PWID field may index a table for interlace frame (e.g. Tables 1, 2 as shown in FIG. 6.). Bit 10 of the load window microcode command 500 may represent a logical input/output buffer (“LIOBN”) field that may indicate if the hardware accelerator is loading LUMA or loading CHROMA data. Thus, in some embodiments, and as shown in FIG. 6, when the LIOBN field is set to 0, CHROMA data may be loaded using Table 1 of FIG. 6 and LUMA data may be loaded if the LIOBM field is set to 1 using Table 2 of FIG. 6.

In some embodiments, tables such as those illustrated in FIG. 6 may be added to the hardware accelerator and accessed if the, INT FRM field of the microcode command 400 of FIG. 4 is set to 1 and the TAB SEL field of the microcode command 500 of FIG. 5 is also set to 1. In some embodiments, Table 1 and Table 2 may be hardwired tables.

In some embodiments, the input/output buffer 106 may be defined by an x-axis and a y-axis and in some embodiments of Table 1 and Table 2, the X column may represent a coordinate on an X-axis of the input buffer 106 and the Y column may represent a Y-axis of the input buffer 106. The W column may represent a pixel width on the X-axis from a starting point of (X, Y) and the H column may represent a pixel width on the Y-axis from the starting point (X, Y). For example, if the LIOBN field has a value of 0 and WID has a value of 3, then CHROMA data may be loaded, with a WID of 3 that refers to Table 1. Accordingly, data may be loaded into the input/output buffer 106 having a staring point of (0,10) with the loaded data being 8 pixels wide on the X-axis and 6 pixels wide on the Y-axis from the starting point.

### De-Blocking Method

De-blocking an interlace frame may require filtering of each field separately where an interlace frame may comprise an odd field and an even field. A hardware accelerator, such as the hardware accelerator 100 of FIG. 1, may provide support for three filtering modes of operations, such as, but not limited to, overlapping transform, in-loop transform and a combination of an overlapping transform followed by an in-loop transform. In some embodiments, the combination algorithm may be utilized to process interlace frame because interlace frames may require filtering in 16 lines that include 8 top and bottom fields in the horizontal direction and odd/even fields in the vertical direction.

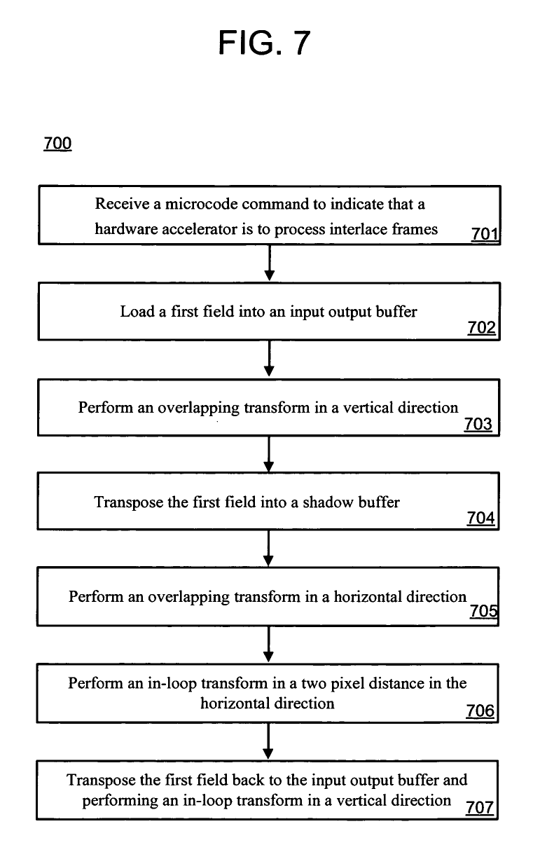

At FIG. 7, an embodiment of a method 700 is shown. The method 700 may be executed by any combination of hardware, software, and firmware, including but not limited to, the hardware accelerator 100 of FIG. 1. At 701 a microcode command is received at the hardware accelerator to indicate that the hardware accelerator is to process interlace frames. Next, at 702 a first field is loaded into an input/output buffer. Next at 703, an overlapping transform is performed in a vertical direction and the first field is transposed into a shadow buffer at 704. Next, at 705, an overlapping transform is performed in a horizontal direction. At 706, an in-loop transform is performed in a two-pixel distance in the horizontal direction. At 707, the first field is transposed back to the input/output buffer and an in-loop transform is performed in a vertical direction. In some embodiments the process may be repeated using a second field of an interlace frame. In some embodiments the first field may be an even field of an interlace frame and the second field may be an odd field of the interlace frame

Filtering may be performed at pixel edges. Therefore, a hardware accelerator 100 may have several buffers including, but not limited to, logical input/output buffers for LUMA data and for CHROMA data, line buffers, and shadow buffers. In some embodiments, the hardware accelerator 100, when not filtering interlace frames, may support filtering in 4-pixel wide boundaries. For filtering interlace frames, 4-pixel wide boundaries may not have a high enough resolution and thus, for interlace frames, in-loop transform filtering may require 2-pixel wide boundaries.

### Masks

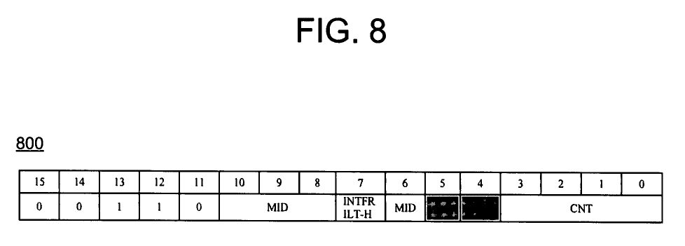

FIG. 8 illustrates an embodiment of a microcode command 800 to set horizontal/vertical masks for interlace frames. A set horizontal/vertical filtering masks microcode command 800 may allow one or more horizontal and/or vertical edge masks to be used. The microcode command 800 may comprise a 4-bit mask identification (“MID”) field. In some embodiments the MID field may comprise bits 6, 8, 9, and 10 where bit 6 is the most significant bit. Since the MID field may comprise 4 bits, up-to 16 different horizontal/vertical Edge Filtering Masks may be defined simultaneously.

The mask count “CNT” field may comprise 4 bits and may indicate a quantity of sets of masks to be defined by subsequent writes. For example, a CNT of 0 may indicate that 8 sets will be written.

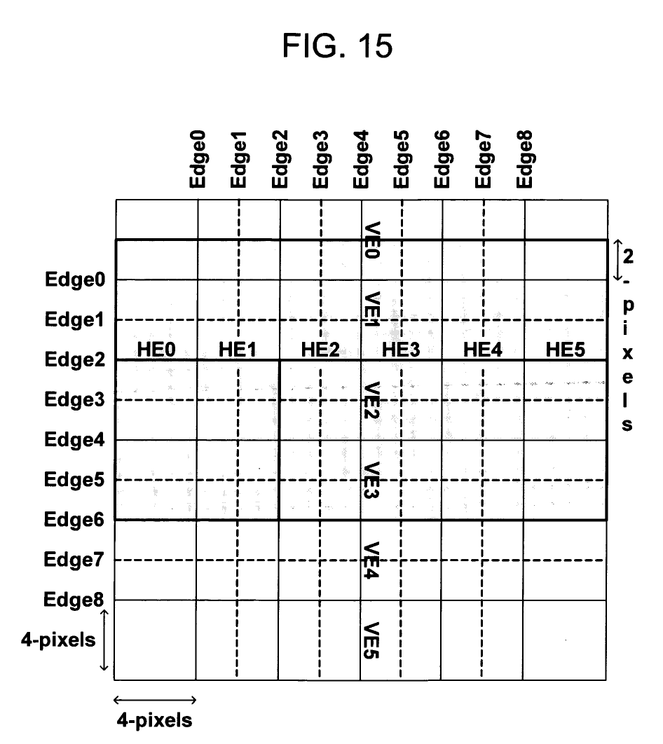

In some embodiments, bit 7 of the microcode command 800 may define an interlace in-loop transform horizontal field “INTFR ILT-H”. If bit 7 is set and the INT FRM field as described with respect to FIG. 4 is set then in-Loop transform horizontal filtering may cover a determined number of edges each having a 2-pixel wide boundary. For example, if the INTFR ILT-H field is set to a predetermined value then 9 edges each 2-pixels wide may be covered as illustrated in FIG. 15.

In some embodiments, if the INT FRM field of the microcode command 400 of FIG. 4 is set to 1, and the INTFR ILT-H field of the microcode command 800 of FIG. 8 is set to process interlace frames, then each mask may specify which of the 9 possible 2-pixel wide horizontal sub-edges may be enabled for filtering on a given horizontal edge. Specifying which sub-edges may be enabled for filtering on a given horizontal edge may be applied to horizontal direction in-loop transforms into a shadow buffer, such as the shadow buffer 107 of FIG. 1.

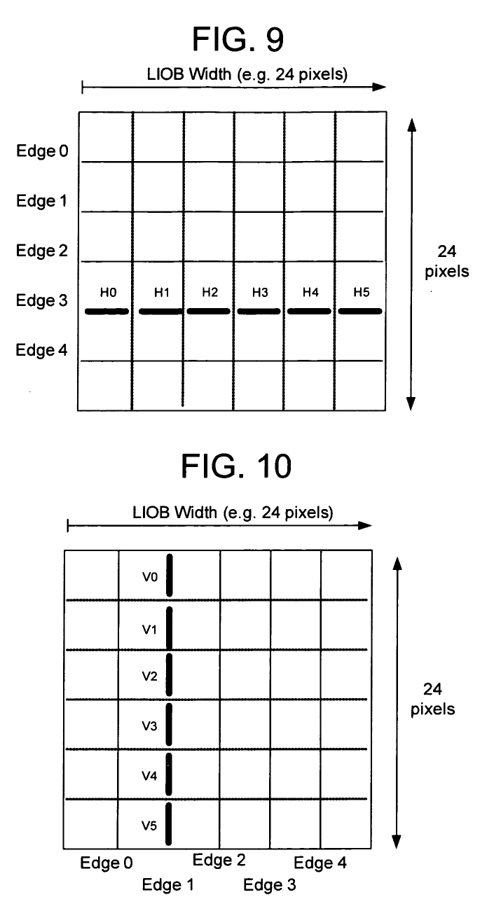

Now referring to FIG. 9, an embodiment of a plurality of horizontal edges is illustrated. In some embodiments, the plurality of horizontal edges may be defined with respect to a current input/output buffer. In some embodiments, FIG. 9 may illustrate a mask lining up each of the plurality of horizontal edges. In some embodiments, a mask may not be attached to any particular edge of the plurality of horizontal edges.

Now referring to FIG. 10, an embodiment of a plurality of vertical edges is illustrated. In some embodiments, FIG. 10 may illustrate a mask lining up with a plurality of vertical edges defined with respect to one or more logical input/output buffers. In some embodiments, masks may not be attached to any particular edge and accordingly, FIG. 10 may illustrate an example of a mask that may line up with vertical edges defined with respect to a current content of a logical input/output buffer.

### Transpose and Clamp

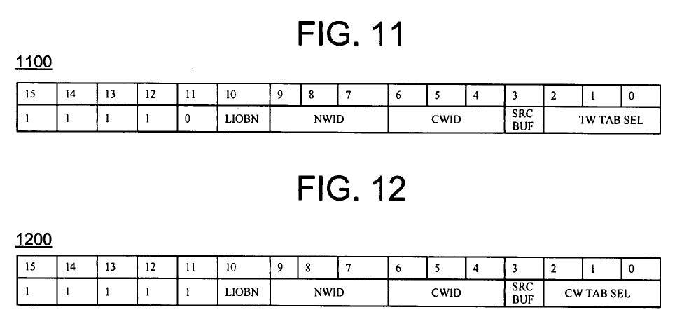

Now referring to FIG. 11, an embodiment of a microcode command 1100 is shown. In some embodiments, the microcode command 1100 may be a transpose window command 1100. In some embodiments, Bit 3 of the microcode command 1100 may define a source buffer “SRC BUF” field that defines a source area to transpose. The transpose operation may transpose video data from the source area to a destination area by a transpose control logic unit, such as, but not limited to the TM 108 as described with respect to FIG. 1. For example, the transpose window microcode command 1100 may trigger a transpose operation on a first input/output buffer as the source area with the destination area in a shadow buffer when a SRC BUF field is set to ‘0’. In some embodiments, when the SRC BUF field is set to ‘1’, the source area may be the shadow buffer and the destination area may be one or more input/output buffers. In some embodiments, the source transposition area may be defined by a processing window identifier (“PWID”).

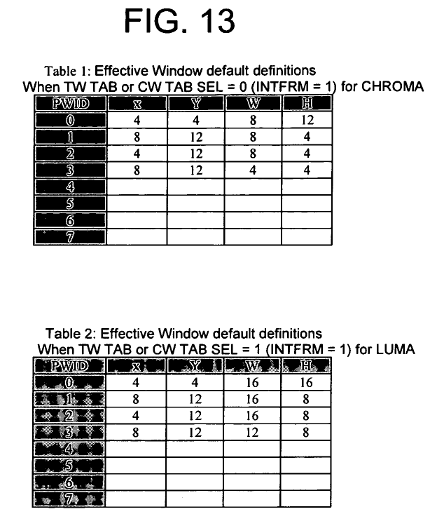

In some embodiments, when a normalized window identifier (“NWID”) and clipping window identifier (“CWID”) are equal, the NWID field and the CWID field may define a default effective window where, the effective window is an area of video data that may be transposed. When the NWID field and the CWID field are not equal, the effective window may be calculated based as a function of NWID, CWID, and Bottom/Right/Top/Left flags “BRTL” (not shown). In some embodiments, the BRTL flags may comprise flags to define a Bottom/Right/Top/Left of a MB being processed associated with a specific logical input/output buffer. In some embodiments, the BRTL flags may indicate a relative position of the MB being processed to a hardware accelerator. The effective window may be the processing window or PWID as defined by values stored in hardwired tables, such as Table 1 and Table 2 of FIG. 13 if the INT FRM field of microcode command 400 as described above is set.

A hardwired table defined by the transpose window table select field (“TW TAB SEL”) (e.g. bits 0, 1, and 2 of microcode command 1100) may be used to access a transpose window table, such as, but not limited to, the tables of FIG. 13. The TW TAB SEL field may identify a default effective window table indexed by the NWID field (e.g. bits 7, 8, and 9) and the CWID field (e.g. bits 4, 5, and 6) when the INT FRM bit as described with respect to FIG. 4 is set. For example, if the TW TAB SEL field is set to 0 then Table 1 of FIG. 13 may be selected. Similarly, when the TW TAB SEL is set to 1, Table 2 of FIG. 13 may be selected. In some embodiments, transposing a matrix of pixels that relies on filtering in a second direction may be achieved at a higher rate as multiple pixels are accessed per clock cycle from memory.

Now referring to FIG. 12, an embodiment of a microcode command 1200 is shown. In some embodiments, the microcode command 1200 may be a clamping window command. A clamping window command may perform a clamp operation over an area of pixels. In some embodiments, the clamping operation may be performed on a pixel-by-pixel basis. For example, for an area to be clamped, each pixel within the area may be clamped if the pixel has a value that is greater than 255 or if the pixel has a value that is less than zero.

A hardwired table defined by the clamping window table select field (“CW TAB SEL”) (e.g. bits 0, 1, and 2 of microcode command 1200) may be used to access a clamping window table, such as, but not limited to the tables of FIG. 13. The clamping window table may be indexed by NWID (e.g. bits 7, 8, and 9) and CWID (e.g. bits 4, 5, and 6) and may define the effective window of pixels to be clamped. In some embodiments when an INT FRM field is set, the CW TAB SEL field may be used to select the table. For example, if the CW TAB SEL field is set to 0 then Table 1 of FIG. 13 may be selected. Similarly, when the CW TAB SEL field is set to 1, Table 2 of FIG. 13 may be selected.

In some embodiments, a clamping table may be used in conjunction with a transpose window table. An executed transpose microcode command 1100 that may transpose video data to a shadow buffer such as shadow buffer 107 of FIG. 1, and may be followed by an executed clamping microcode command 1200 that may allow full edge filtering operation in a second (e.g. horizontal or vertical) direction for overlapping transforms before an in-loop operation starts. After completing an overlapping transform, and before executing an in-loop transform, a clamping operation may be performed. In some embodiments, a matrix of size 16×8 may be associated with 2 LUMA matrices and a matrix of 8×4 may be associated with 4 CHROMA 4 matrices.

### Edge Filtering Operation

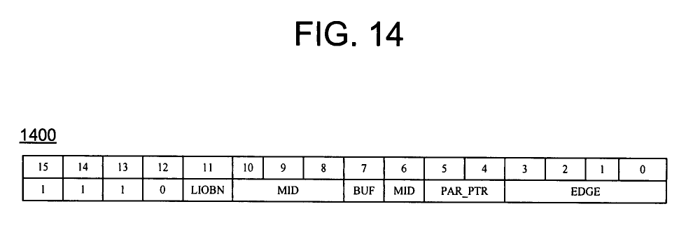

An embodiment of a micro command 1400 is illustrated in FIG. 14. In some embodiments, the microcode command 1400 may be an edge filter microcode command that may filter a given edge of a current logical input/output buffer, such as the logical input/output buffer 106 of FIG. 1. In one embodiment, such as that illustrated in FIG. 14, bits 0 through 3 may define an EDGE field that identifies an edge to filter. When an INTFR ILT-H bit, as described with respect to FIG. 8 above is set, a hardware accelerator, such as that described with respect to FIG. 1, may perform an interlace transform in a horizontal direction using 2-pixel wide macro blocks. A mask identifier (“MID”) field associated with an edge numbering may comprise 4 bits, for example bits 6, 8, 9, and 10 of microcode command 1400. In some embodiments, a value of the MID field may be in a range of 0 though 15.

In some embodiments, an edge filter may be a vertical mask (“VMASK”) or a horizontal mask (“HMASK”). The VMASK may be used if the buffer is in a normal (e.g. not transposed) order while HMASK may be used if the buffer is in a transposed order. Filtering may be performed from top to bottom in a vertical direction on every edge set to 1 by the Edge Filtering Mask selected. In some embodiments, if the input/output buffer is transposed, filtering from top to bottom may be equivalent to filtering in a direction from a left to a right.

A type of filter to be applied and a number of pixels to filter on each side of the edge may be defined by a field of an EFILT configuration unit, such as that described above with respect to FIG. 1. In some embodiments, if the input/output buffer is in a normal order, vertical edges may be filtered; else horizontal edges may be filtered.

In some embodiments, when a MID field is selected and is associated with one or more edges to be filtered, and a INTFR ILT-H field is set in the microcode command 800 as described above with respect to FIG. 8, and the INT FRM field is set in the microcode command 400, then an in-loop transform in a horizontal direction may be performed in a shadow buffer using 2-pixel wide macro blocks.

The amount of pixels to be transposed may be defined by an effective window of size N×M, where N and M are integers. The pixels may be transposed from the input/output buffer to the shadow buffer, and when microcode command 1400 is executed with the MID and EDGE fields specified, an in-loop transform may be performed on the defined sub-edges.

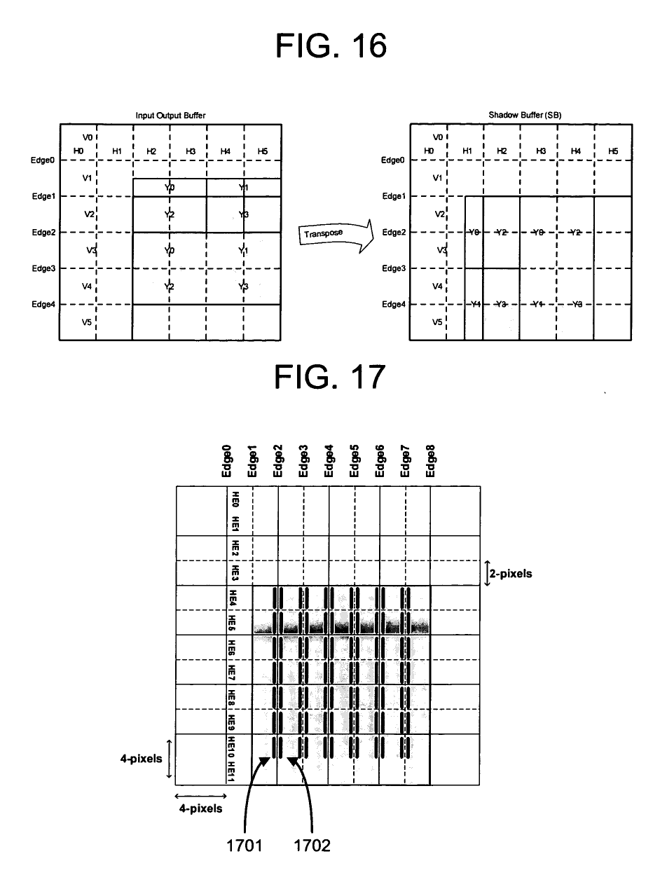

Now referring to FIG. 16, an embodiment of blocks and edges are illustrated. In some embodiments, FIG. 16 illustrates an example of an effective window transposing pixels from an input/output buffer to a shadow buffer. In some embodiments, the shaded area may be a transposed area of video data that comprises a plurality of macro blocks.

FIG. 17 illustrates an embodiment of blocks and edges. In some embodiments, FIG. 17 may be an example of interlace frame filtering performed in a shadow buffer having an even frame field 1701 and an odd frame field 1702. Interlace frames may require that filter edges be filtered in 2-pixel widths when performing an In-Loop transform in a horizontal direction.

### Unloading Pixels

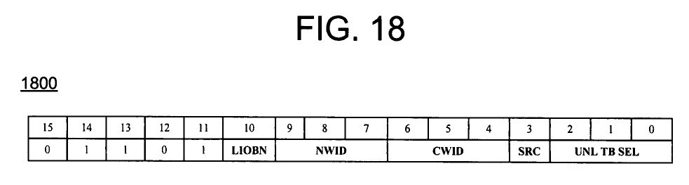

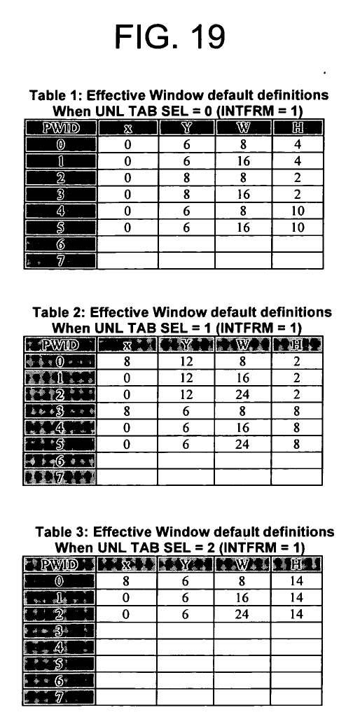

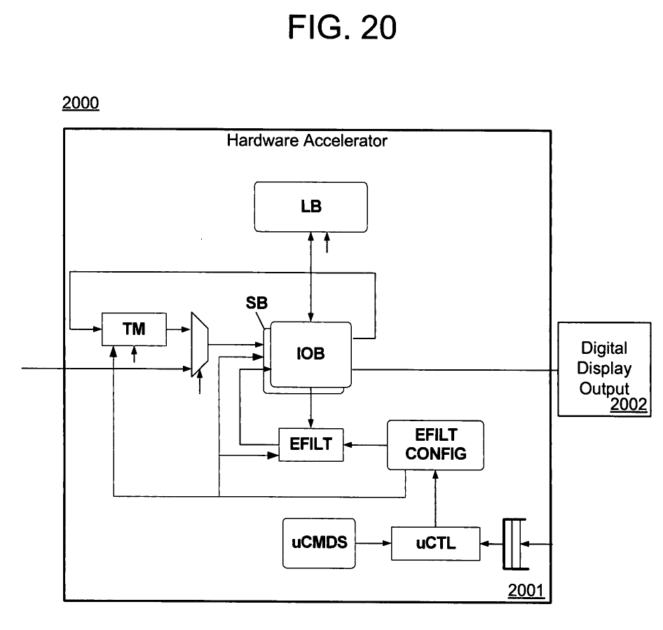

Now referring to FIG. 18, an embodiment of a microcode command 1800 is shown. The microcode command 1800 may comprise an unload table select (“UNL TB SEL”) field. The UNL TB SEL field may be a three-bit field that identifies a default effective window table indexed by a NWID field and a CWID field. The effective window to be unloaded may be defined by an N×M matrix where N and M are integers. In some embodiments, three tables, such as, but not limited to Table 1, Table 2, and Table 3 of FIG. 19 may support the microcode command 1800 to unload a set of N×M pixels for LUMA and for CHROMA. In some embodiments, an unload microcode command 1800 may be used to extract filtered output data from a hardware accelerator.

In some embodiments, an effective window (“EFF WIN”) may be defined by the PWID field of Table 1, Table 2, and/or Table 3 of FIG. 19 when the NWID field has the same value as the CWID field. In some embodiments, Table 1, Table 2, and/or Table 3 of FIG. 19 may be hardwired tables. Each table may use the values (x, y, w, h) as indexed by the PWID field when the INT FRM field is set with respect to FIG. 4 and the UNL TAB SEL field is set to select one of the three above-mentioned tables. If the UNL TAB SEL field equals 0 then Table 1 of FIG. 19 may be selected. When the UNL TAB SEL field equals 1, then table 2 of FIG. 19 may be selected and, if the UNL TAB SEL field equals 2, then table 3 of FIG. 19 may be selected.

For example, if the NWID field equals 4, and the CWID field equals 4, and the UNL TAB SEL field equals 0, then table 1 may be referenced. Since both NWID and CWID equal 4 then a PWID value of 4 may be referenced in table 1. A PWID value of 4 may show an offset and size chosen with the values x=0, y=6, H=10, and W=8. Accordingly this illustrates that a matrix of size 8×10 may be unloaded with a (X, Y) starting point of (0,6).

The foregoing disclosure has been described with reference to specific embodiments thereof. It will, however, be evident that various modifications and changes may be made thereto without departing from the broader spirit and scope set forth in the appended claims.

What is claimed is:

1. A method comprising:
loading video data into a hardware accelerator that is not adapted to receive interlace frames, wherein the video data comprises interlace frames;
configuring the hardware accelerator to receive interlace frames; and
de-blocking the video data via the hardware accelerator.

2. The method of claim 1, wherein the configuring comprises:
receiving a microcode command at the hardware accelerator to indicate that the hardware accelerator is to process interlace frames.

3. The method of claim 1, wherein de-blocking the video data comprises:
loading an first field into an input/output buffer;
performing an overlapping transform in a vertical direction;
transposing the first field into a shadow buffer;
performing an overlapping transform in a horizontal direction;
performing an in-loop transform in a two pixel distance in the horizontal direction; and
transposing the first field back to the input/output buffer and performing an in-loop transform in a vertical direction.

4. The method of claim 3, further comprising:
loading an second field into an input/output buffer;
performing an overlapping transform in a vertical direction;
transposing the second field into a shadow buffer;
performing an overlapping transform in a horizontal direction;
performing an in-loop transform in a two pixel distance in the horizontal direction; and
transposing the second field back to the input/output buffer and performing an in-loop transform in a vertical direction.

5. The method of claim 4, wherein the first field is an even field of an interlace frame and the second field is an odd field of the interlace frame

6. An apparatus comprising:
a hardware accelerator to de-block video data, comprising interlace frames;
a command queue;
an edge filter unit, to perform filtering;
an edge filter configuration unit, to configure the edge filter unit based on a plurality of coding standards,
wherein the input to the hardware accelerator is video data comprising one or more interlace frames, and a microcode instruction is to indicate that the hardware accelerator is to process interlace frames.

7. The apparatus of claim 6, further comprising
a micro controller, to accelerate an operation defined in a command;
a micro command cache, to store instructions;
an input/output buffer;
a shadow buffer;
a plurality of line buffers;
a multiplexer; and
a transpose control logic unit.

8. The apparatus of claim 6, wherein the microcode instruction has a length of two words.

9. The apparatus of claim 6, wherein setting a bit in the microcode is to indicate that the hardware accelerator is to process interlace frames.

10. The apparatus of claim 7, wherein the edge filter configuration unit is to receive the microcode from the microcontroller and is to transmit a signal to the transpose control logic unit, the edge filter unit and the input/output buffer to indicate that that the hardware accelerator is to process interlace frames.

11. The apparatus of claim 6, wherein a video data is loaded based on a plurality of tables.

12. The apparatus of claim 11, wherein the plurality of tables are hardwired.

13. A system comprising:
a digital display output; and
a hardware accelerator to de-block video data, comprising interlace frames;
a command queue;
an edge filter unit, to perform filtering;
an edge filter configuration unit, to configure the edge filter unit based on a plurality of coding standards,
wherein the input to the hardware accelerator is a video data comprising one or more interlace frames, and a microcode instruction is to indicate that the hardware accelerator is to process interlace frames.

14. The system of claim 13, wherein a microcode instruction indicates that the hardware accelerator is to process interlace frames.

15. The system of claim 14, wherein the microcode instruction has a length of two words.

16. The system of claim 14, wherein setting a bit in the microcode is to indicate that the hardware accelerator is to process interlace frames.

17. The system of claim 13, further comprising
a micro controller, to accelerate an operation defined in a command;
a micro command cache, to store instructions;
an input/output buffer;
a shadow buffer;
a plurality of line buffers;
a multiplexer; and
a transpose control logic unit.

18. The system of claim 17, wherein the edge filter configuration unit is to receive the microcode from the microcontroller and is to transmit a signal to the transpose control logic unit, the edge filter unit and the input/output buffer to indicate that that the hardware accelerator is to process interlace frames.

19. The system of claim 13, wherein video data is loaded based on a plurality of tables.

20. The system of claim 19, wherein the plurality of tables are hardwired.
